(19) United States
(12) Patent Application Publication
(10) Pub. No.: US 2022/0061295 A1
(43) Pub. Date: Mar. 3, 2022

(54) FISHING TOOL IDENTIFICATION DEVICE AND FISHING TOOL MANAGEMENT SYSTEM

(71) Applicant: GLOBERIDE, Inc., Tokyo (JP)

(72) Inventor: Motoki FURUKAWA, Toyko (JP)

(21) Appl. No.: 17/411,693

(22) Filed: Aug. 25, 2021

(30) Foreign Application Priority Data
Aug. 27, 2020 (JP) 2020-143243

(51) Int. Cl. A01K 97/12; G06K 7/10; G06K 7/14

(52) U.S. Cl. CPC A01K 97/125; G06K 7/10366; G06K 7/10722; G06K 7/1417; G06K 7/1413

(57) ABSTRACT

A fishing tool identification device according to an embodiment of the present disclosure is attachable to a fishing tool, and is configured to include a tag identification portion capable of reading an identification tag that identifies the fishing tool.

### CROSS-REFERENCE TO RELATED APPLICATIONS

This application claims priority under 35 U.S.C. § 119 to Japanese Patent Application No. 2020-143243 filed on Aug. 27, 2020, in the Japanese Intellectual Property Office, the entire contents of each hereby incorporated by reference.

### FIELD

The present disclosure relates to a fishing tool identification device capable of identifying fishing tools and a fishing tool management system equipped with said device, for the purpose of managing fishing tools.

### BACKGROUND

Conventionally, when fishing, a fishing reel, a fishing rod, a lure, a weight, and other various fishing tools that are considered appropriate for a fish species, fishing method and the like are selected, carried and used for fishing. The number of combinations of fishing tools selected each time is enormous, and fishermen have remembered, or physically taken a note of, these combinations as necessary.

In recent years, however, an accounting system has been proposed for making smooth payments at stores. Such an accounting system is configured of an RF tag attached to each product, a reader/writer that reads the information of the RF tag, and a register that is communicably connected to the reader/writer.

As such a system, for example, Patent Literature 1 discloses a reader that reads information from an RF tag attached to an article, having an antenna that emits radio waves for communicating with the RF tag, a shield portion that accommodates the antenna, has an opening wider than the article, and reads information from the RF tag with the shield portion open, as well as an information delivery system.

### SUMMARY

There are various kinds of fishing tools, and even when trying to select a specific combination of fishing tools from the past experience, carrying and using a specific combination of fishing tools, what fishermen could do was only to rely on their memories or refer to notes physically taken from time to time. Further, there has been no attempt to apply the system according to Patent Literature 1 to the field of fishing. Moreover, even if such system is actually applied, since the information to be given to each of various fishing tools is diverse, there was a problem that a simple application does not work.

The present disclosure has been made in view of the above circumstances, and the objective thereof is to provide a fishing tool identification device capable of identifying fishing tools and a fishing tool management system equipped with said device, which are capable of identifying fishing tools. Other purposes of the present disclosure will become apparent upon reference to this specification in its entirety.

A fishing tool identification device according to an embodiment of the present disclosure is attachable to a fishing tool, and is configured to include a tag identification portion (tab identification unit) that can read an identification tag for identifying the fishing tool.

A fishing tool identification device according to an embodiment of the present disclosure includes a display (display unit or display portion), wherein the display is configured to be capable of displaying the information of the identification tag of the fishing tool.

A fishing tool identification device according to an embodiment of the present disclosure includes a transmitter (transmitting unit or transmitting portion), wherein the transmitter is configured to be capable of transmitting the information of the identification tag of the fishing tool to an external device.

In a fishing tool identification device according to an embodiment of the present disclosure, the fishing tool is configured to include at least one of a fishing reel, a fishing rod, a fishing line or a rig.

In a fishing tool identification device according to an embodiment of the present disclosure, the rig is configure to include at least one of a lure, an artificial bait, a hook, a float, a weight, a ground bait container, a bait, a fish-attracting plate or a balance.

In a fishing tool identification device according to an embodiment of the present disclosure, the identification tag is configured to be any one of a bar code, a QR-code® or a RFID tag. Further, in the fishing tool identification device according to an embodiment of the present disclosure, the tag identification portion is configured to be capable of reading at least one of a bar code, a QR code®, or a RFID tag.

A fishing tool identification device according to an embodiment of the present disclosure is configured to include a fishing tool image identification portion (fishing tool image identification unit) capable of identifying an image of a fishing tool.

In a fishing tool identification device according to an embodiment of the present disclosure, the tag identification portion is a camera, and is configured to image-recognize the identification tag with the camera.

A fishing tool management system according to an embodiment of the present disclosure is configured to include any one of the above-mentioned fishing tool identification devices, and a fishing tool management device including a receiver (receiving unit or receiving portion) that receives the information of the identification tag from the fishing tool identification device. Further, in the fishing tool management system according to an embodiment of the present disclosure, the fishing tool management device is configured to include a storage (storing unit or storing portion), and to store the detailed information of the identification tag in the storage.

In a fishing tool management system according to an embodiment of the present disclosure, the fishing tool management device includes a display and is configured to display the information of the identification tag.

In the fishing tool management system according to an embodiment of the present disclosure, the fishing tool management device includes a transmitter/receiver, and is configured to receive the detailed information of the identification tag from an outside portion. Further, in the fishing tool management system according to an embodiment of the present disclosure, the outside portion includes an external cloud server.

In a fishing tool management system according to an embodiment of the present disclosure, the fishing tool management device includes a display, and is configured to display the information of the identification tag and the detailed information.

According to the above embodiment, it is possible to provide a fishing tool identification device capable of identifying fishing tools, and a fishing tool management system equipped with said device, which can accurately and reliably manage various fishing tools.

### BRIEF DESCRIPTION OF THE DRAWINGS

FIG. 1 is a diagram illustrating a fishing tool management system 1 according to an embodiment of the present disclosure.

FIG. 2 is a diagram illustrating a method of management by a fishing tool identification device 10 according to an embodiment of the present disclosure.

FIG. 3 is a diagram illustrating a method of management by the fishing tool identification device 10 according to an embodiment of the present disclosure.

FIG. 4 is a diagram illustrating a method of management by the fishing tool identification device 10 according to an embodiment of the present disclosure.

FIG. 5 is a diagram illustrating a method of search by the fishing tool identification device 10 according to an embodiment of the present disclosure.

### DETAILED DESCRIPTION

Hereinafter, the embodiments of the present disclosure will be described in detail with reference to the accompanying drawings. Components that are common in the plurality of drawings are denoted by the same reference numerals throughout the plurality of drawings. It should be noted that each drawing is not necessarily scaled for convenience of explanation.

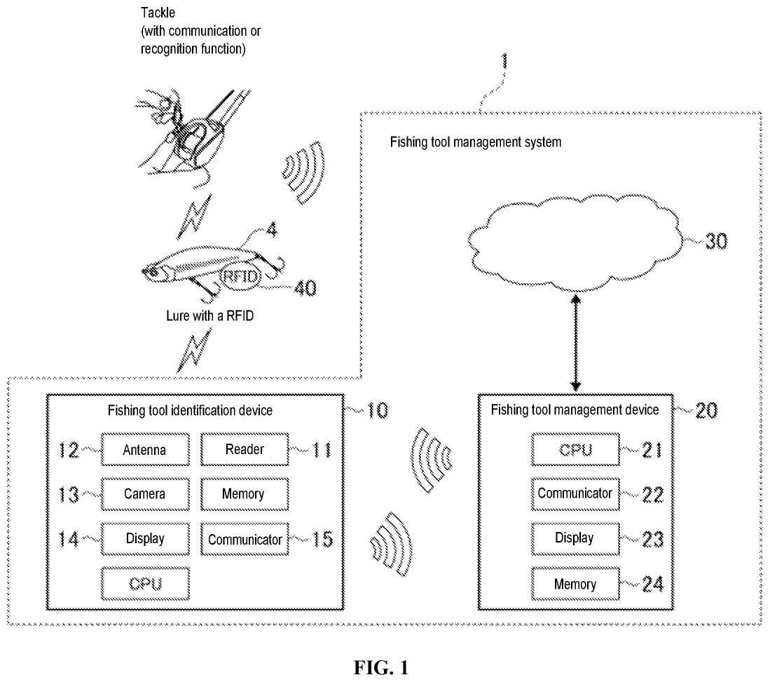

First, the fishing tool management system 1 according to an embodiment of the present disclosure will be described with reference to FIG. 1. The fishing tool management system 1 according to an embodiment of the present disclosure includes the fishing tool identification device 10 and a fishing tool management device 20 connected to the fishing tool identification device 10. In the illustrated example, the fishing tool management device 20 is connected to an external device or a system (a cloud in the illustrated example) 30; however, another embodiment is possible where the external device is not connected to the system 30. Here, the connection refers to direct connection or connection via another device or system by wired or wireless connection, and is not limited to a specific connection method. The fishing tool identification device 10 and the fishing tool management device 20 may also be realized with the same device.

Here, a fishing tool (“fishing tool(s)” though it is sometimes called “tackle”) includes at least any one of a fishing reel 2, a fishing rod 3, a rig 4, or a fishing line 5. Further, the rig 4 includes at least one of a lure, an artificial bait, a hook, a float, a weight, a ground bait container, a bait, a fish-attracting plate or a balance, but is not limited thereto (the rig 4 is a lure in the illustrated example). Normally, the rig 4 is attached to one end of the fishing line 5, and has a hook for a fish to bite. Various rigs are used depending on a target fish and fishing method. Further, identification tags (RFID tags in the illustrated example) are attached to the respective fishing tools (lures in the illustrated example). Also, if the rig 4 is a bait, the identification tag may be attached to a package containing the bait. Here, the possible identification tag may be a bar code, a QR code® and the like, but also includes various other tags, and is not limited to a specific mode of a tag.

Next, the fishing tool identification device 10 according to an embodiment of the present disclosure will be described. The fishing tool identification device 10 according to an embodiment of the present disclosure is attachable to a fishing tool, and is configured to include a tag identification portion (reader (reading unit or reading portion)) 11 that can read the identification tag 40 to identify the fishing tool. Further, the fishing tool identification device 10 may also be the fishing reel 2, the fishing rod 3, other fishing tool itself and a lure box itself, but also includes other various tools.

The fishing tool identification device 10 according to an embodiment of the present disclosure makes it possible to identify each fishing tool, and to accurately and reliably manage various fishing tools. It is considered that slight differences in weight, density, shape, and the like of a rig such as a lure, a float and a hook among the fishing tools can greatly affect catch of fish, and a user may select such items from among various types of rigs. However, though it is often difficult to distinguish various rigs by their appearance, it possible to easily identify a rig whose identification by appearance is difficult by identifying an identification tag of each fishing tool with the fishing tool identification device 10 according to an embodiment of the present disclosure. Moreover, a user often replaces a rig to fit the changing circumstances while fishing; however, as the fishing tool identification device 10 according to an embodiment of the present disclosure enables the user to record the replacement of a rig by simply bringing the replacement rig closer to the tag information identification portion, the user can record the replacement without adding to his/her burden even if the rig need be replaced frequently.

The ID identification tag (identification tag) 40 is provided with ID information that identifies each fishing tool, and the ID information can be obtained with the tag identification portion 11. In the fishing tool identification device 10 according to an embodiment of the present disclosure, a passive RF tag can be used as the ID identification tag 40, and a RFID reader can be used as the identification portion 11. This eliminates the need for power supply to the ID identification tag 40, and enables non-contact ID identification. An antenna 12, a camera 13, a CPU 16, a storage (memory portion (memory unit)) 17, a power supply (not illustrated), and a control circuit (not illustrated) are also provided. The antenna 12 reads RFID tags and the like. Further, the camera 13 reads a QR code° and images of a fishing tool itself. Here, a passive tag such as a RFID has no components such as a power supply and therefore, has advantages that it can be easily downsized and waterproofed, and has no need for battery replacement. For this reason, it is possible to attach said tag even to a small rig such as a lure without impairing its original function as much as possible because it does not affect the sinking speed in water, fluid resistance and the like.

Further, the fishing tool identification device 10 according to an embodiment of the present disclosure includes a display 14, wherein the display 14 is configured to be capable of displaying the information of the identification tag 40 of a fishing tool.

The fishing tool identification device 10 according to an embodiment of the present disclosure includes a transmitter (communicator (communicating unit or communicating portion) 15, wherein the transmitter 10 is configured to be capable of transmitting the information of the identification tag 40 of a fishing tool to an external device (e.g., the fishing tool management device 20).

In the fishing took identification device 10 according to an embodiment of the present disclosure, the fishing tool, as described above, is configured to include at least one of the a fishing reel, a fishing rod, a fishing line, or a rig.

In the fishing tool identification device 10 according to an embodiment of the present disclosure, the rig 4, as described above, is configured to include at least one of a lure, an artificial bait, a hook, a float, a weight, a ground bait container, a bait, a fish-attracting plate or a balance, but is not limited thereto.

In the fishing tool identification device 10 according to an embodiment of the present disclosure, the identification tag 40 is configured to be any one of a bar code, a QR-code® or a RFID tag. Further, the identification tag 40 is not limited thereto, and may also be, for example, an image of a fishing tool itself and the like instead.

In the fishing tool identification device 10 according to an embodiment of the present disclosure, the tag identification portion 11 is configured to be capable of reading at least one of a bar code, a QR code®, or a RFID tag. Further, the tag identification portion 11 is not limited thereto, and may also read, for example, an image of the fishing tool itself and the like instead of the identification tag 40.

Here, the fishing tool identification device 10 according to an embodiment of the present disclosure may be configured to include a fishing tool image identification portion (fishing tool image identification unit) capable of identifying an image of a fishing tool. In this case, the fishing tool image identification portion may be, for example, a camera, and may be configured to image-recognize the fishing tool itself with the camera. When a fishing tool is recognized by the fishing tool image identification portion, a tag identification portion is not required. Further, in the case where a camera is attached to a portable information terminal for example, the camera can be used, and a tag need not be attached to a rig, which offers an advantage that a system can be built without costing more.

In the fishing tool identification device 10 according to an embodiment of the present disclosure, the tag identification portion 11 is a camera, and may be configured to image-recognize the identification tag with the camera.

As described above, the fishing tool management system 1 according to an embodiment of the present disclosure is configured to include the fishing tool identification device 10, and the fishing tool management device 20 with a receiver (transmitter) 21 that receives the information of the identification tag 40 from the fishing tool identification device 10.

The fishing tool management system 1 according to an embodiment of the present disclosure makes it possible to identify each fishing tool and accurately and reliably manage various fishing tools.

Further, in the fishing tool management system 1 according to an embodiment of the present disclosure, the fishing tool management device 20 includes a display 23, and is configured to display the information of the identification tag 40.

In the fishing tool management system 1 according to an embodiment of the present disclosure, the fishing tool management device 20 includes a transmitter/receiver (communicator) 22, and is configured to receive the detailed information of the identification tag (including the information of the fishing tool when image-recognizing said fishing tool itself (hereinafter, the same applies)) from an external device or the system (a cloud in the illustrated example) 30. Here, the possible external device or system may be an external shared cloud, dedicated cloud or cloud server, but also includes various other modes. For example, in the fishing tool management system 1 according to an embodiment of the present disclosure, the fishing tool management device 20 may be configured to include a storage 24, and to store the detailed information of the identification tag in the storage 24.

Here, the above detailed information may be the fishing tool characteristic information stored in an external device or system (e.g., cloud) when a fishing tool is identified by an image of the fishing tool itself. The information is supposed to be handled in the same manner as the information stored in RFID or QR-Code®. Further, such detailed information may include information (usually meaning additional information that cannot be stored in a RFID tag and the like) that is stored in an external device or system (e.g., a cloud) and that is used when the detailed information on the fishing tool need be displayed on a management device or equipment. Further, the detailed information referred to above may also be the information stored in an external device or a system (e.g., a cloud), or may be for updating the information stored in a management device or equipment.

Further, in the fishing tool management system 1 according to an embodiment of the present disclosure, the fishing tool management device 20 includes the display 23, and is configured to display the information of the identification tag 40 and the detailed information.

Here, the fishing tool management device 20 includes the storage (memory) 24, and can store the information of the identification tag 40 and the detailed information. Further, the fishing tool management device 20 includes a processor (processing unit or processing portion) (CPU) 21, and performs processing to display the information of the identification tag 40 and the detailed information. Here, the fishing tool management device 20 may be, for example, a portable terminal, a smart phone, or the like, but is not limited thereto, and includes various modes.

Next, a case where a fishing tool identification method is to read a QR code® will be described. A two-dimensional code such as a bar code and a QR code® can be used as the ID identification tag 40, and a bar code reader or an image recognition means such as a camera can be used as the identification device (identification portion) 11. If it is difficult to attach the ID identification tag 40 to a fishing tool itself for reasons such as waterproofing and downsizing, a list on which photographs and bar codes of fishing tools are printed may be separately prepared. This enables to choose a combination of a target fishing tool and an identification tag and to obtain an ID using the identification portion 11, instead of recognizing the fishing tool. Similar effects can also be achieved this way as in the example of the above embodiment.

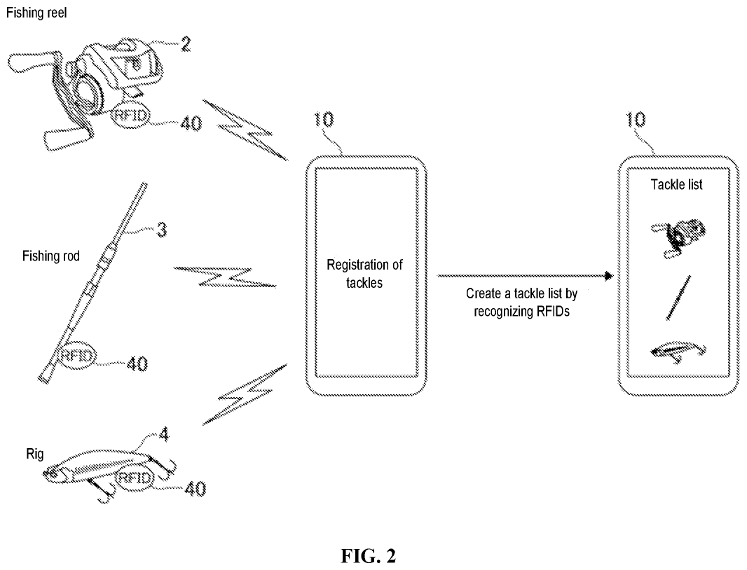

Next, the use of the fishing tool identification device 10 (initially registered) according to an embodiment of the present disclosure will be described with reference to FIG. 2. As described above, the fishing tool identification device 10 can recognize an identification tag of each fishing tool with its tag information identification portion 11. In the illustrated example, after purchase of each fishing tool, the information of each fishing tool is read from each identification tag 40 of the fishing reel 2, the fishing rod 3, and the rig 4. Thereafter, a list of purchased fishing tools can be created by registering each read fishing tool with the fishing tool identification device 10. In this manner, the fishing tools purchased by a user can be managed by the fishing tool identification device 10. Further, such a list may also be transmitted from the fishing tool identification device 10 to the above-described fishing tool management device 20 so that it can be managed on the fishing tool management device 20.

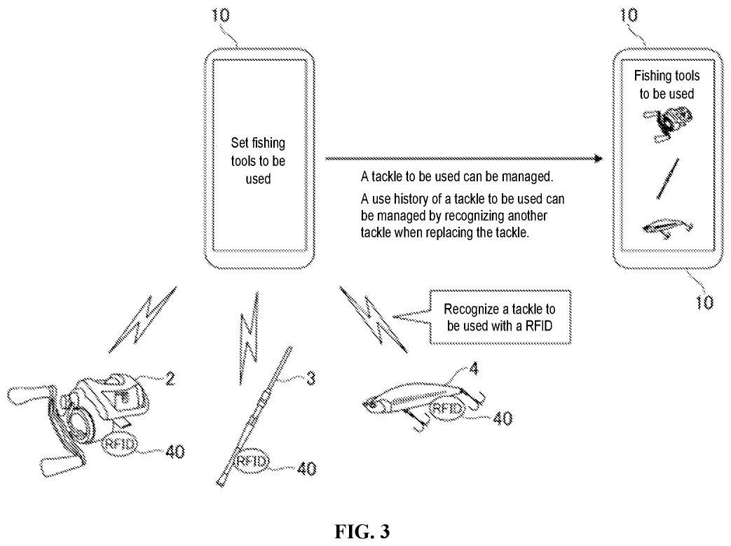

Next, the use of the fishing tool identification device 10 (while actual fishing) according to an embodiment of the present disclosure will be described with reference to FIG. 3. As described above, the fishing tool identification device 10 can recognize an identification tag of each fishing tool with its tag information identification portion 11. In the illustrated example, the information of the fishing tools to be used is read from each identification tag 40 of the fishing tools, the fishing reel 2, the fishing rod 3 and the rig 4 that are used for actual fishing. Thereafter, a history of use can be created from the read information of each fishing tool by the fishing tool identification device 10. This enables to manage the history of use of each fishing tool, and to significantly improve fishermen's satisfaction with fishing by allowing the user to confirm a desired combination of fishing tools or the like from the previous use history at the time of the next actual fishing. Further, such a use history may be transmitted from the fishing tool identification device 10 to the above-described fishing tool management device 20, so that it can be managed on the fishing tool management device 20.

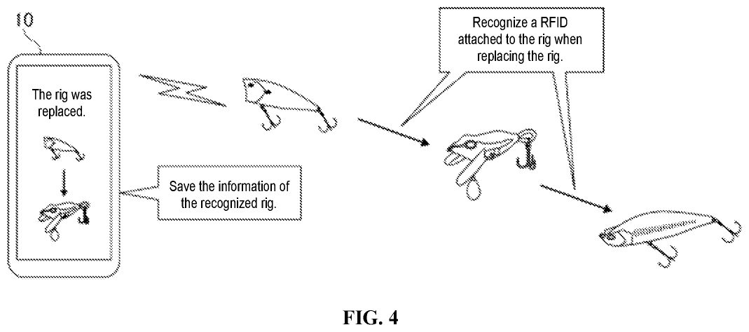

Next, a method for managing the use history of the rig 4 will be described with reference to FIG. 4. Note that, in the illustrated example, the rig 4 will be described as an example, but other fishing tools may also be used. FIG. 4 shows a management method when the rig 4 is replaced during actual fishing. As illustrated, when the first rig is replaced, a new rig to be used is made recognized by the fishing tool identification device 10, and the recognized information is stored (the first rig has already been stored as information in the fishing tool identification device 10). Then, even when replacing the rig with a new rig 4, it is made recognized by the fishing tool identification device 10, and is stored. In this way, the use history of the rig during actual fishing may be created and stored.

It is possible to significantly improve fishermen's satisfaction with fishing by recognizing and storing the replacement of the rig 4, enabling to manage the use history of each fishing tool, so that a user can confirm a desired combination of fishing tools or the like from the previous use history at the time of the next actual fishing. Further, such a use history may also be transmitted from the fishing tool identification device 10 to the above-described fishing tool management device 20, so that it can be managed on the fishing tool management device 20.

Further, this also enables to refer to the previous use history of the rig 4 on the same day during actual fishing. Moreover, it is possible to manage the rig 4 owned by a user by recognizing the rig 4 and also storing the information on when, where and how many fishes are caught with the rig 4 outside actual fishing.

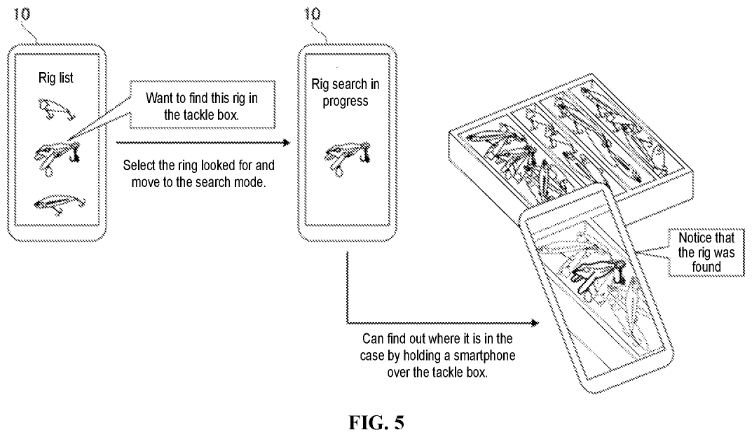

Next, a method for searching the rig 4 will be described with reference to FIG. 5. Note that, in the illustrated example, the rig 4 will be described as an example, but other fishing tools may also be used. FIG. 5 shows an example of a case where a specific rig in a list of rigs held by a user is found from a rig box in which rigs are stored. As illustrated, a user selects a target rig from the list displayed on the fishing tool identification device 10 in which his/her own rigs are registered and stored. Then, the fishing tool identification device 10 shifts to the search mode, and the selected rig can be easily found from a plurality of rigs with identification tags in the rig box by holding the fishing tool identification device 10 over the rig box.

The possible fishing tool identification device may include a portable terminal device, a wearable terminal, or a fish finder, but is not limited thereto. Further, as described above, the fishing tool identification device may be either the fishing reel 2 or the fishing rod 3, or may be another device.

The dimensions, materials and arrangements of each component described herein are not limited to those explicitly described in the embodiments, and each component can be modified to have any dimension, material and arrangement that can be included within the scope of the present disclosure. Further, components that are not explicitly described herein may be added to the described embodiments, or some of the components described in each embodiment may also be omitted.

### DESCRIPTION OF THE NUMERICAL REFERENCES

1 Fishing tool management system

2 Fishing reel

3 Fishing rod

4 Rig

5 Fishing line

10 Fishing tool identification device

11 Identification device (identification portion)

12 Antenna

13 Camera

14 Display

15 Transmitter (communicator)

20 Fishing tool management system

21 Processor (CPU)

22 Transmitter/receiver (communicator)

23 Display

24 Storage (memory)

30 External device or system (cloud)

What is claimed is:

1. A fishing tool identification device attachable to a fishing tool, comprising a tag identification portion capable of reading an identification tag that identifies the fishing tool.

2. The fishing tool identification device according to claim 1, comprising a display, wherein the display can display the information of the identification tag of the fishing tool.

3. The fishing tool identification device according to claim 1, comprising a transmitter, wherein the transmitter can transmit the information of the identification tag of the fishing tool to an external device.

4. The fishing tool identification device according to claim 1, wherein the fishing tool includes at least one of a fishing reel, a fishing rod, a fishing line, or a rig.

5. The fishing tool identification device according to claim 4, wherein the rig includes at least one of a lure, an artificial bait, a hook, a float, a weight, a ground bait container, a bait, a fish-attracting plate, or a balance.

6. The fishing tool identification device according to claim 1, wherein the identification tag is any one of a bar code, a QR-code® or a RFID tag.

7. The fishing tool identification device according to claim 6, wherein the tag identification portion can read at least one of a bar code, a QR code® and a RFID tag.

8. The fishing tool identification device according to claim 1, wherein the tag identification portion is a camera, and wherein the camera image-recognizes the identification tag.

9. The fishing tool identification device comprising a fishing tool image identification portion capable of identifying an image of a fishing tool.

10. A fishing tool management system comprising: a fishing tool identification device according to claim 1; and a fishing tool management device including a receiver that receives the information of the identification tag from the fishing tool identification device.

11. The fishing tool management system according to claim 10, wherein the fishing tool management device comprises a display and displays the information of the identification tag.

12. The fishing tool management system according to claim 10, wherein the fishing tool management device comprises a storage, and stores the detailed information of the identification tag in the storage.

13. The fishing tool management system according to claim 10, wherein the fishing tool management device comprises a transmitter/receiver, and receives the detailed information of the identification tag from an external portion.

14. The fishing tool management system according to claim 13, wherein the external portion includes an external cloud server.

15. The fishing tool management system according to claim 12, wherein the fishing tool management device includes a display, and displays the information of the identification tag and the detailed information.
